(19) United States
(12) Patent Application Publication
(10) Pub. No.: US 2012/0122016 A1
(43) Pub. Date: May 17, 2012

(54) Fuel Cell Durability Through Oxide Supported Precious Metals in Membrane

(75) Inventors: Ruichun Jiang, Rochester, NY (US); Junliang Zhang, Rochester, NY (US); Zhongyi Liu, Troy, MI (US); Frank Coms, Fairport, NY (US); Craig S. Gittleman, Rochester, NY (US)

(73) Assignee: GM GLOBAL TECHNOLOGY OPERATIONS, INC., Detroit, MI (US)

(21) Appl. No.: 12/946,180

(22) Filed: Nov. 15, 2010

(51) Int. Cl. H01M 8/10

(52) U.S. Cl. 429/492; 429/494; 429/535

(57) ABSTRACT

A fuel cell includes an anode, a cathode, and an ion conducting membrane interposed between the anode and cathode. The ion conducting membrane includes a base layer that has an ion conducting polymer and additive layer that has a metal supported on an oxide support, the oxide support scavenging hydroxyl radicals formed during fuel cell operation.

### FIELD OF THE INVENTION

The present invention relates to fuel cell assemblies with improved resistance to chemical degradation.

### BACKGROUND OF THE INVENTION

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”), to provide ion transport between the anode and cathode. Fuel cells produce electrical energy by processing reactants, for example, through the oxidation and reduction of hydrogen and oxygen.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode and reduction of oxygen at the cathode. Protons flow from the anode through the ionically conductive polymer membrane to the cathode where they combine with oxygen to form water, which is discharged from the cell. The MEA is sandwiched between a pair of porous gas diffusion layers (“GDL”) which in turn are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

Durability is one of the factors that determine the commercial viability of a fuel cell. For example, a vehicle fuel cell needs to last at least 5,000 hours. Such a high durability requirement challenges the polymer electrolyte membrane materials under consideration for a fuel cell. Particularly, the PEM is known to degrade due to reaction with reactive species such as radicals formed as a side product during normal fuel cell operation.

Accordingly, the present invention provides an improved degradation resistant membrane for fuel cell applications and a method for forming such a membrane.

### SUMMARY OF THE INVENTION

The present invention solves one or more problems of the prior art by providing in at least one embodiment a fuel cell with improved degradation resistance. The fuel cell includes an anode, a cathode, and an ion conducting membrane interposed between the anode and cathode. The ion conducting membrane comprises a base layer that includes an ion conducting polymer and additive layer including a metal catalyst supported on an oxide support. Characteristically, the additive layer is positioned on the cathode side of the membrane. The function of the oxide support is to disperse the metal catalyst for achieving high surface area and reactive activity to work as a hydroxyl radical scavenger for improving membrane chemical stability, to help retain water in the membrane for better fuel cell performance at dry conditions. The metal catalyst alleviates crossover of reactant gases (e.g., H₂, O₂) and by-product (e.g., H₂O₂) and thus reduces membrane and electrode degradation. The combination of metal catalyst and the oxide support enhances membrane and electrode durability in fuel cell operation.

In another embodiment of the present invention, a fuel cell with improved degradation resistance is provided. The fuel cell includes an anode, a cathode, and an ion conducting membrane interposed between the anode and cathode. The ion conducting membrane comprises a base layer that includes an ion conducting polymer and an additive layer that includes a precious metal supported on a CeO₂ or MnO₂ support. Characteristically, the additive layer is positioned on the cathode side of the membrane. The function of the oxide support is to disperse the precious metals for achieving high surface area and reactive activity, to work as a hydroxyl radical scavenger for improving membrane chemical stability, to help retain water in the membrane for better fuel cell performance at dry conditions. The precious metals alleviate crossover of reactant gases (e.g., H₂, O₂) and by-product (e.g., H₂O₂) and thus reduce membrane and electrode degradation. The combination of precious metals and the oxide support enhances membrane and electrode durability in fuel cell operation.

In another embodiment of the present invention, a method of forming a membrane electrode assembly for a fuel cell is provided. The method comprises forming an additive mixture comprising a metal catalyst and an oxide. A reducing agent is added to this mixture such that a reaction ensues thereby forming solid particles of the metal catalyst supported on the oxide. The solid particles are collected and then combined with an ionomer to form an additive/ionomer mixture. The additive/ionomer mixture is applied to a base layer to form a multilayer membrane having an additive layer disposed over the base layer. A cathode is applied to the multilayer membrane proximate to the additive layer and an anode is applied to the multilayer membrane proximate to the base layer.

### BRIEF DESCRIPTION OF THE DRAWINGS

Exemplary embodiments of the present invention will become more fully understood from the detailed description and the accompanying drawings, wherein:

FIG. 1 provides a schematic illustration of a fuel cell system incorporating a multilayer ion conducting membrane;

FIG. 2 provides a schematic illustration of a multilayer ion conducting membrane;

FIG. 3 provides a schematic of a method for forming a multilayer membrane with a layer containing additives;

FIGS. 4A and 4B provide plots showing the effect of additives in the multilayer membrane in reducing gas crossover through the membrane under H₂/O₂ condition, (A) H₂ permeability, and (B) O₂ permeability;

FIG. 5 provides plots of the polarization curve and the high frequency resistance (HFR) showing the effect of additives in the multilayer membrane on fuel cell performance at 95° C., 55% RH, H₂/Air, 150 kPa. Higher performance is demonstrated to the MEA with Pt/CeO₂ additive inside of the membrane compared to the MEA without membrane additive, and the MEA with Pt/C as the membrane additive;

FIG. 6 provides plots of the open circuit voltage (OCV) and the fluoride release rates (FRR) which demonstrate that a membrane with Pt/CeO₂ additive possesses enhanced durability and reduced fluoride release rate in the OCV tests;

FIG. 7 provides a bar chart showing that a membrane with Pt/CeO₂ additive has a lower value of average FRR and membrane fluoride inventory loss, compared to membrane without additive and membrane with Pt/C additive, after 200 hours of OCV tests; and

FIG. 8 provides a bar chart of the cell voltage values at 1.5 A/cm² current density before and after 200 hours of OCV testing. A MEA with Pt/CeO₂ additive inside of the membrane holds higher cell voltage after OCV tests than that without additive, or with Pt/C as the additive.

### DESCRIPTION OF THE INVENTION

Reference will now be made in detail to presently preferred compositions, embodiments and methods of the present invention which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

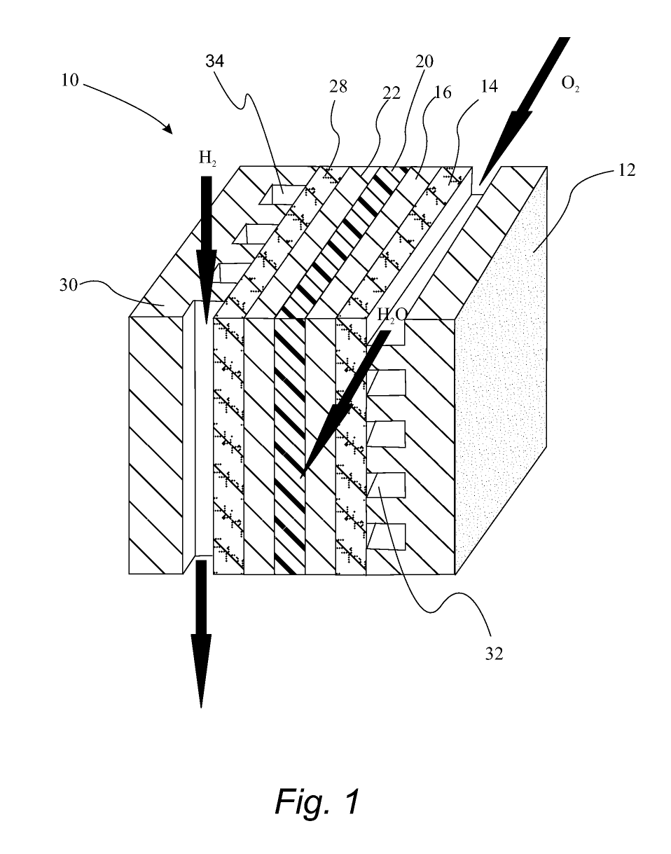

With reference to FIG. 1, an example of a fuel cell assembly for inclusion in a fuel cell stack is provided. Fuel cell 10 includes flow field plate 12. Flow field plate 12 includes a plurality of channels 32 for introducing a first gas into fuel cell 10. Typically, this first gas comprises oxygen. Diffusion layer 14 is disposed over flow field plate 12. First catalyst layer 16 is disposed over diffusion layer 14. Fuel cell 10 further includes ion conducting membrane (also referred to as the PEM) 20 which is disposed over first catalyst layer 16. In an embodiment of the present invention, ion conducting membrane 20 is a multilayer structure as set forth below in more detail. Second catalyst layer 22 is disposed over ion conducting membrane 20. Fuel cell 10 also includes flow field plate 30 with gas diffusion layer 28 interposed between second catalyst layer 22 and flow field plate 30. In a refinement, one or both of flow field plates 12 and 30 is made from a metal such as stainless steel. Flow field plate 30 includes a plurality of channels 34 for introducing a fuel gas (e.g., hydrogen) into fuel cell 10.

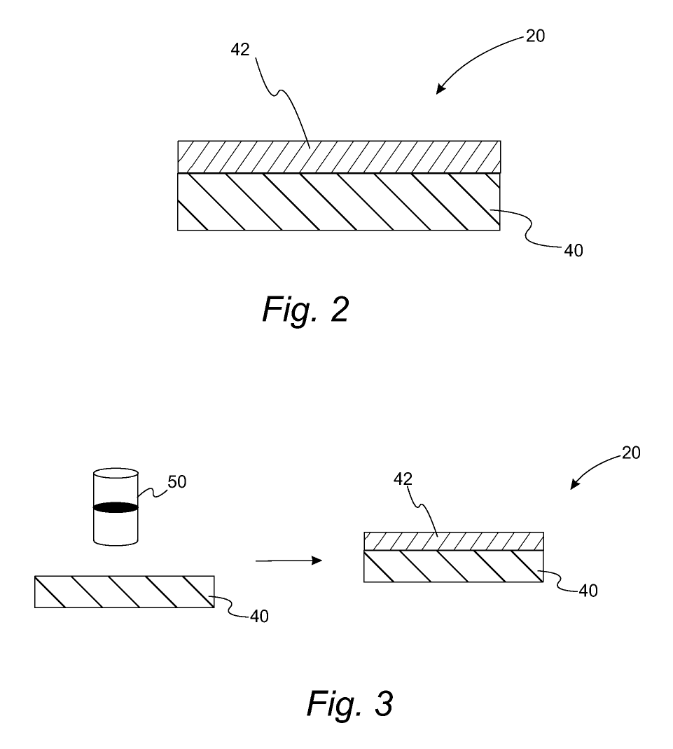

With reference to FIG. 2, a multilayer fuel cell membrane is provided. Membrane 20 includes base layer 40 and additive layer 42. Additive layer 42 includes oxide supported metal catalysts. In a variation, the term “metal catalyst” includes elemental metals as well as metal-containing compounds. Typically, the metal catalysts are precious metals or precious metal-containing compounds. Characteristically, additive layer 42 is positioned on the cathode side of membrane 20. The function of the oxide support is to disperse the metals for achieving high surface area and reactive activity, to work as a hydroxyl radical scavenger for improving membrane chemical stability, to help retain water in the membrane for better fuel cell performance at dry conditions. The metals alleviate crossover of reactant gases (e.g., H₂, O₂) and by-product (e.g., H₂O₂) and thus reduce membrane and electrode degradation. The combination of the metal catalyst and the oxide support enhances membrane and electrode durability in fuel cell operation. In a refinement, the combination of the metal catalyst and the oxide support reduces the fluoride release rates (FRR) under open circuit conditions at various relative humidities (RH) to a level less than or equal to 1×10⁻⁶ gF/cm²·h. Advantageously, both the oxide support and the precious metals provide benefits to alleviate membrane and MEA degradation. Moreover, as set forth below, a MEA with such a membrane demonstrates improved fuel cell durability. Typically, additive layer 42 includes a metal catalyst (e.g., precious metal) in an amount from about 0.001 mg/cm² to about 0.8 mg/cm². In a further refinement, additive layer 42 includes a metal catalyst in an amount from about 0.005 mg/cm² to about 0.5 mg/cm². Preferred catalysts include, but are not limited to, platinum (Pt), palladium (Pd), mixtures of metals Pt and molybdenum (Mo), mixtures of Pt and cobalt (Co), mixtures of Pt and ruthenium (Ru), mixtures of Pt and nickel (Ni), mixtures of Pt and tin (Sn), and combinations thereof. The catalysts are impregnated onto an oxide support that acts to reduce or inhibit fuel cell degradation usually by scavenging radicals. Suitable oxide supports include, but are not limited to, CeO₂, MnO₂, and combinations thereof. Typically, additive layer 42 includes an oxide support in an amount from about 0.001 mg/cm² to about 0.8 mg/cm². In a further refinement, additive layer 42 includes an oxide support in an amount from about 0.005 mg/cm² to about 0.5 mg/cm². In still another variation, base layer 40 has a thickness from about 0 to about 50 microns and the additive layer has a thickness from about 1 to about 30 microns. In yet another variation, base layer 40 has a thickness from about 1 to about 50 microns and the additive layer has a thickness from about 3 to about 30 microns.

In another variation, the ion conducting membrane comprises a hydrocarbon membrane. In still another refinement, the ion conducting membrane comprises a membrane selected from the group consisting of homogenous membranes and non-homogenous membranes. Homogeneous membranes typically are membranes formed from a single polymeric composition while non-homogeneous membranes may include addition components such as a support. Examples of non-homogeneous membranes include, but are not limited to, reinforced membranes using an expanded polytetrafluoroethylene (ePTFE) support contained therein. In this variation, the support is positioned within one or both of the base layer and the additive layer.

As set forth above, the fuel cell of the present embodiment includes a first and a second catalyst layer. Typically, the first catalyst layer and the second catalyst layer each independently include a precious metal. In a variation, the first catalyst layer and the second catalyst layer each independently include a catalyst support. In a further refinement, the first catalyst layer and the second catalyst layer each independently include a catalyst in an amount from about 0.01 mg/cm² to about 8 mg/cm².

In another embodiment of the present invention, a method of forming a membrane electrode assembly for a fuel cell is provided. The method comprises forming an additive mixture comprising a metal-containing compound and an oxide. A reducing agent is added to this mixture such that a reaction ensues thereby forming solid particles of the metal-containing compound supported on the oxide. The solid particles are collected and then combined with an ionomer to form an additive/ionomer mixture. The additive ionomer mixture is applied to a base layer to form a multilayer membrane having an additive layer disposed over the base layer. A cathode is applied to the multilayer membrane proximate to the additive layer and an anode is applied to the multilayer membrane proximate to the base layer. In a variation, the anode and cathodes are independently formed from a liquid composition that supports catalysts and ionomers. In a refinement of such variation, the anode and cathodes are formed by applying the relevant liquid compositions to a side of the ion conducting membrane.

With reference to FIG. 3, a schematic illustrating a variation of the preparation of ion conducting membrane 20 is provided. The oxide supported precious metal particles contained in mixture 50 are applied as a layer onto base layer 40. Mixture 50 includes a metal catalyst supported on an oxide (“supported catalyst”) and an ionomer. Typically, the weight ratio of the supported catalyst (e.g., Pt/CeO₂) to ionomer is from about 0.0005 to about 0.5. In another refinement, the ratio of supported catalyst to ionomer is from about 0.001 to about 0.1. Therefore, the multilayer membrane includes additive layer and base layer. The additive layer contains oxide supported precious metal particles and ionomers. The base layer is a membrane to which the additive layer is attached. For instance, as shown in FIG. 3, an additive membrane layer formed by drying a solution containing ionomer, Pt/CeO₂ and dispersion solvent, is coated onto a base membrane layer.

In a variation of the present invention, an oxide supported metal catalyst such as Pt/CeO₂ is prepared as follows. A predetermined amount of a metal catalyst precursor is dissolved in a weakly acidic aqueous solution. In a refinement, the amount of metal catalyst precursor is such that the metal is present in an amount from about 0.0005 moles/liter to about 0.01 moles/liter. In another refinement, the amount of metal catalyst precursor is such that the metal is present in an amount from about 0.001 moles/liter to about 0.008 moles/liter. A predetermined amount of an oxide powder is added into the solution containing the metal precursor. In a refinement, the amount of oxide is from about 0.0005 moles/liter to about 0.01 moles/liter. In another refinement, the amount of oxide is from about 0.001 moles/liter to about 0.008 moles/liter. The solution is stirred during the addition of the oxide and then subjected to ultrasonication while stirring. The stirring is stopped upon the observation of a uniform milk-like mixture. The beaker is then heated while being stirred at an elevated temperature (e.g., about 80° C. for 2 hours). A reducing reagent, such as HCOOH, HCO₂Na or NaBH₄, in 5-10 stoichiometry (i.e., mole ratio of reducing agent to metal is 1-10) is then added into the mixture to reduce the metal precursor (e.g., Pt⁴⁺ to Pt) while stirring. In a refinement, the amount of reducing agent is from about 0.005 moles/liter to about 0.1 moles/liter. In another refinement, the amount of reducing agent is from about 0.01 moles/liter to about 0.08 moles/liter. Stirring is continued for an additional period of time (i.e., about 2 hours). The resulting solid particles of Pt/CeO₂ in the mixture are collected through vacuum filtration and rinsed 2-3 times with copious deionized water. The particles are then dried in a vacuum at 60-80° C. for 3 hours. The weight ratio of Pt to CeO₂ can be adjusted by changing the amount of Pt precursor and CeO₂ used in the reaction.

The following examples illustrate the various embodiments of the present invention. Those skilled in the art will recognize many variations that are within the spirit of the present invention and scope of the claims,

Preparation of oxide supported catalyst. About 1 gram of a platinum precursor such as K₂PtCl₆ or H₂PtCl₆ is dissolved into about 500 ml of dilute aqueous H₂SO₄ solution (e.g., about 10⁻³ N) in a beaker. About 0.5 gram of CeO₂ powder is added into the solution containing the metal precursor. The solution is stirred during the addition of the oxide and then subjected to ultrasonication for about 10 minutes while stirring. The stirring is continued until the observation of a uniform milk-like mixture. The beaker is then heated while being stirred at about 80° C. for 2 hours. A reducing reagent, such as HCOOH, HCO₂Na or NaBH₄, in 1-10 stoichiometry is then added into the mixture to reduce Pt⁴⁺ to Pt while stirring. Stirring is continued for an additional 2 hours. The resulting solid particles of Pt/CeO₂ in the mixture are collected through vacuum filtration and rinsed 2-3 times with copious deionized water. The particles are then dried in a vacuum at 60-80° C. for 3 hours.

Preparation of a coating solution containing Pt/CeO₂ and ionomer. A predetermined amount of Pt/CeO₂ and ionomer solution (e.g., Nafion® DE2020) is added to a solvent with stirring. Suitable solvents include one or more of water, alcohol, and other organic additives. The concentration of Pt/CeO₂ and ionomer, as well as the weight ratio of Pt/CeO₂ to ionomer, are adjusted by adding different amounts of solvent. In this example, the obtained solution has a ratio of Pt/CeO₂ to ionomer of about 1:20 by weight, and a 5 wt % Nafion® concentration.

Preparation of the base membrane layer. The base membrane layer with a predetermined thickness (e.g., 2 to 20 microns) can be in-house coated from ionomer solution, or commercially purchased from any supplier. The in-house coated base layer membrane is obtained by applying ionomer solution onto a flat surface followed by a drying and heat treatment procedure. The thickness of the base layer membrane is controlled by adjusting the amount of solution applied and the ionomer concentration inside of the solution. The base layer membrane is attached onto a leveled porous plate with flat surface. A vacuum can be used underneath the plate to help hold the base layer membrane in place, if desired.

Coat the additive layer containing ionomer and Pt/CeO₂ additive. The additive layer can be coated on the base layer membrane in a shim frame with a specified thickness. The use of the shim frame enables the production of uniform coatings, the thicknesses of which can be controlled by the height of the shim. The shim frame can be made of a material which is dimensionally stable and which does not interact with any of the components of the coating solution. Good-quality shim materials with uniform thickness are commercially available. Suitable materials include, but are not limited to, polyimide film (e.g., DuPont Kapton), polyethylene naphthalate film (PEN) (e.g., DuPont Teonex®), ethylene tetrafluoroethylene (ETFE), stainless steel, and the like. In one of the coating processes using a shim frame coating technique, a frame with a certain thickness of shim film is placed on top of the base layer membrane. The base layer membrane is placed on the flat surface of a plate with porous structure (e.g., graphite plate). Vacuum is applied at the bottom of the graphite plate to hold the base layer membrane in place. The well-mixed solution containing Pt/CeO₂, ionomer and solvent, called coating material, is initially placed on the shim film without contacting the base layer membrane, and then sliding a brush/slide bar through the coating material to cover the whole area of the base layer membrane. The thickness of each pass of coating is determined by the thickness of the shim film and the amount of solid materials (e.g., Pt/CeO₂, ionomer) inside of the coating material. The additive layer coated base layer membrane is then dried at 25° C., 50% RH for 30 min, then heat treated at a temperature typically between 250 to 300° F. for one to six hours. This coating process can be repeated as needed to obtain the thickness required.

For comparison purposes, additional multilayer membranes without any Pt/C or other additives inside of the additive layer are also fabricated with the same thickness as the membrane with Pt/CeO₂ in the additive layer. The membranes with either Pt/C or Pt/CeO₂ as the additive have a Pt loading of 8 ug/cm² of membrane. All of the three types of multilayer PEM membranes (no additive, Pt additive, or Pt/CeO₂ additive) have the same thickness of 15 μm.

The multilayer PEM membrane (with Pt/CeO₂ additive, Pt/C additive and no additive) obtained through the above procedure is assembled into membrane electrode assembly (MEA). The MEA can optionally include a subgasket positioned between the PEM and the catalyst coated gas diffusion media (GDM) on one or both sides. The cathode electrode layer is adjacent to the additive layer of the multilayer membrane. The subgasket has the shape of a frame, and the size of the window is smaller than the size of the catalyst coated GDM and the size of the PEM. In this example, Pt/Vulcan is used to form the electrocatalyst layer and has a Pt loading of 0.4 mg/cm² at the cathode and 0.05 mg/cm² at the anode. The resulting MEA can then be placed between other parts which may include a pair of gas flow field plates, current collector and end plates, to form a single fuel cell.

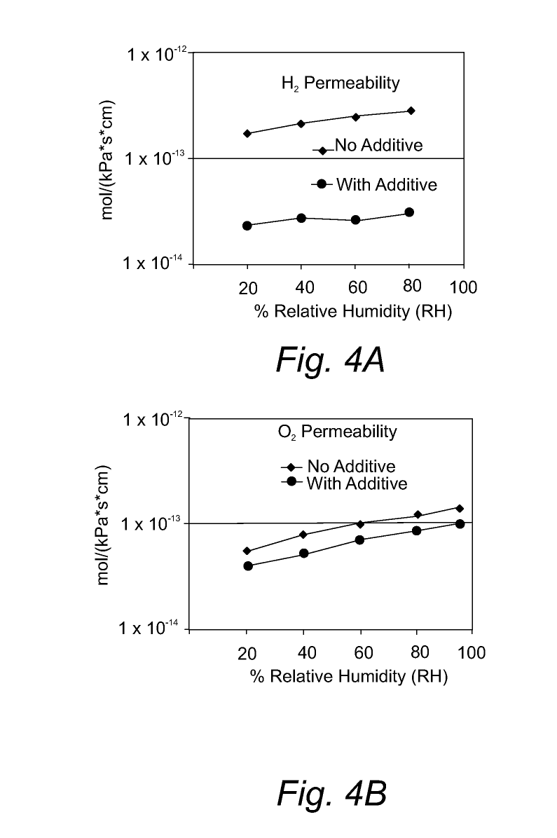

Reactant gas crossover tests. A multilayer membrane with Pt/CeO₂ in the additive layer and without any electrocatalyst layers is compared to a membrane sample without additive. In each case, the membranes are assembled into a fuel cell for reactant gas crossover tests. The tests are conducted under 80° C., 20-95% RH. Pure H₂ is supplied at one side of the membrane and pure O₂ flows at the other side of the membrane. The compositions of outlet gases of H₂ and O₂ are evaluated using a gas chromatograph (GC). Gas crossover values, calculated in permeability by normalization with gas pressure, membrane thickness and area, are shown in FIGS. 4A and 4B. The multilayer membrane with Pt/CeO₂ additive layer demonstrate lower H₂ and O₂ crossover, compared to the membrane with no additive inside. A catalyzed chemical reaction takes place at the Pt active site inside of the multilayer membrane with Pt/CeO₂ additive:

H₂+½O₂→H₂O.

Therefore, significant amounts of H₂ and O₂ are consumed inside of the membrane without reaching to the other side of the multilayer membrane, and result in lower reactant gas crossover.

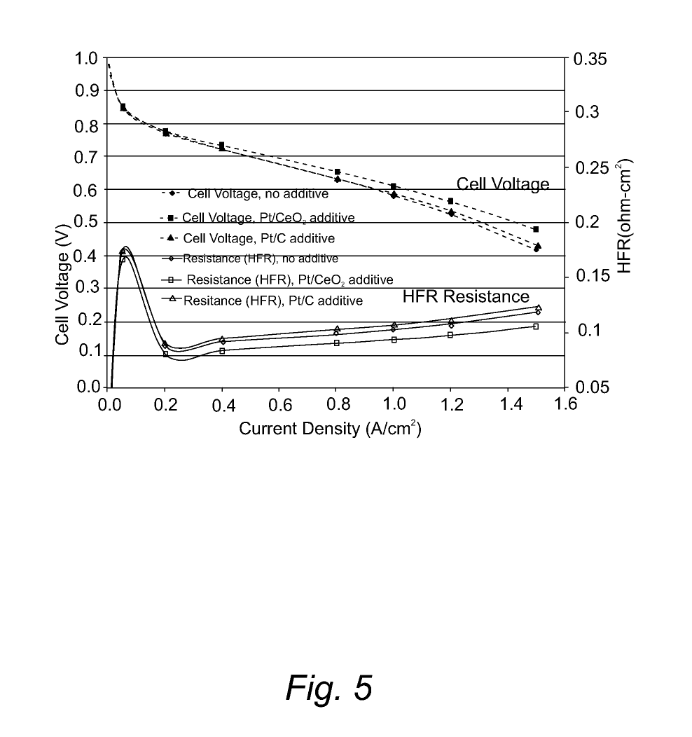

Fuel cell performance. The membrane electrode assemblies (MEAs), with the multilayer membrane containing Pt/CeO₂ in the additive layer, as well as two comparison membrane samples (no additive and Pt/C as the additive) are individually assembled in a fuel cell hardware. Fuel cell performance is then tested: Cell voltage vs. Current density, High frequency resistance (HFR) resistance. The test conditions are 80-95° C., 55-150% RH at the cell cathode outlet. Fuel cell performance data under dry condition, 95° C., 55% RH at the cell cathode outlet is shown in FIG. 5. The MEA with multilayer membrane containing Pt/CeO₂ additive demonstrates better performance than the other comparison samples: higher cell voltage and lower HFR at a given current density. This result indicates that the Pt/CeO₂ additive inside of the multilayer membrane does not drag down the fuel cell performance. By contrast, the CeO₂ particle may help retain water inside of the membrane when the environment is dry. Therefore, the HFRis alleviated and the overall cell performance is improved.

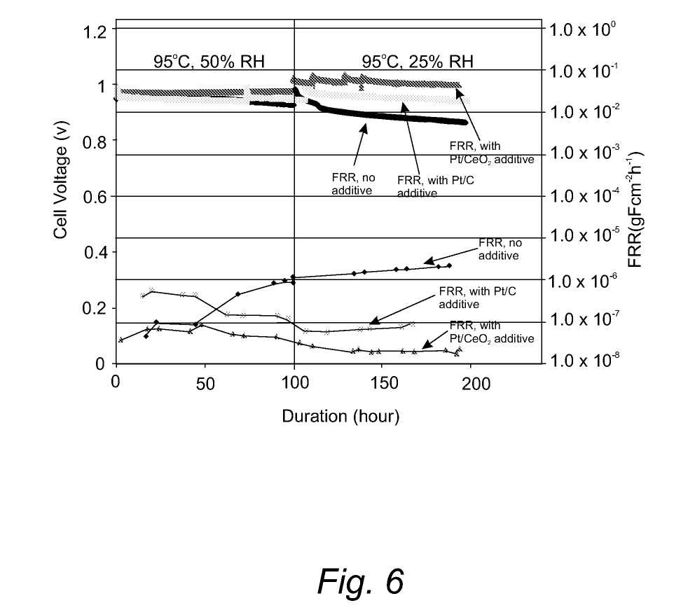

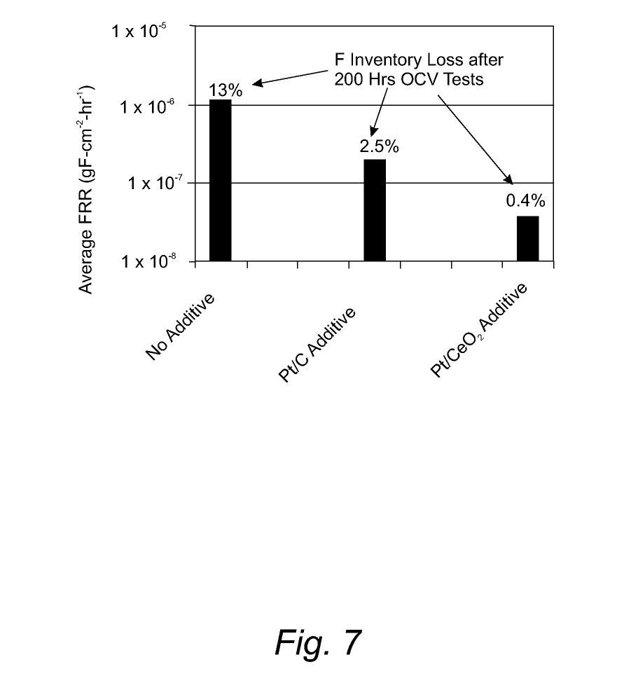

Chemical durability tests under open circuit voltage (OCV). The membrane electrode assemblies (MEAs), with the multilayer membrane containing Pt/CeO₂ in the additive layer, as well as two comparison membrane samples: no additive and Pt/C as the additive, are individually assembled in a fuel cell hardware and tested chemical durability under OCV conditions. As a standard test procedure, the OCV tests are firstly conducted at 95° C., 50% RH for 100 hours duration, and then at 95° C., 25% RH for another 100 hours duration. Under such conditions, the membranes are subject to chemical degradation due to the production of oxidants including hydroxyl radical (.OH) and H₂O₂. During this test, the fuel cell OCV, as well as the fluoride release rate (FRR), are evaluated and recorded. As shown in FIG. 6, the MEA containing Pt/CeO₂ additive in the multilayer membrane demonstrate better durability than the other comparison samples: it holds higher OCV and lower FRR throughout the test duration. A more detailed FRR analysis is shown in FIG. 7, which includes the average FRR values and the accumulated fluoride inventory losses for the three MEAs. The MEA containing multilayer membrane with Pt/CeO₂ additive has the lowest average FRR value and fluoride inventory loss among the three samples. In the membrane with Pt/CeO₂ additive, the CeO₂ works as a hydroxyl radical scavenger and the Pt alleviates crossover of reactant gases (e.g., H₂, O₂) and by-product (e.g., H₂O₂). Therefore, the support material, CeO₂, and the precious metal, Pt, work together to provide double protection to the membrane for improved membrane durability. There might be other benefits of this Pt/CeO₂ additive such as: the CeO₂ may help retain water inside of the membrane, which will alleviate membrane degradation at dry conditions.

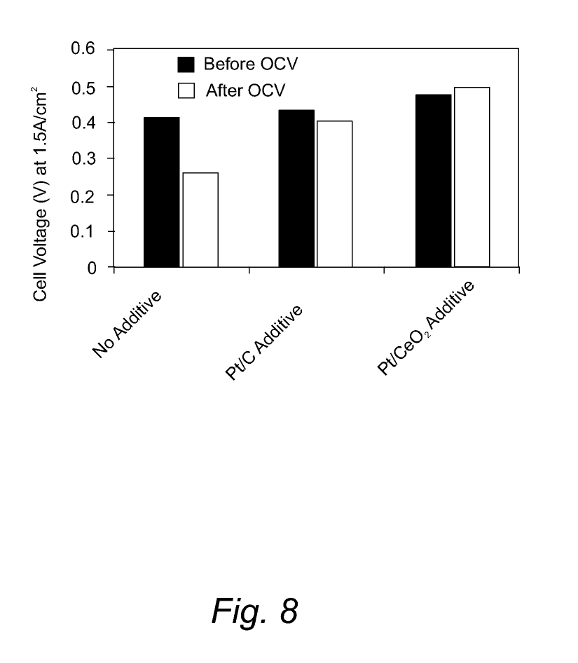

The fuel cell performance tests were conducted after the OCV durability tests, and compared to the performance results before the OCV tests. FIG. 8 shows the cell voltage values before and after OCV tests of the MEAs, with the multilayer membrane containing Pt/CeO₂ in the additive layer, and two comparison membrane samples (no additive and Pt/C as the additive) at 1.5 A/cm², a temperature of 95° C., and 55% RH at the cathode outlet. Compared to other MEAs, the MEA containing Pt/CeO₂ additive in the multilayer membrane showed better performance and less cell voltage loss, after 200 hours of membrane degradation testing.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A fuel cell comprising:
an anode;
a cathode; and
an ion conducting membrane interposed between the anode and cathode, the ion conducting membrane comprising a base layer that includes an ion conducting polymer and an additive layer including a metal catalyst supported on an oxide support, the oxide support scavenging radicals formed during fuel cell operation.

2. The fuel cell of claim 1 wherein the additive layer comprises a precious metal supported on the oxide support.

3. The fuel cell of claim 1 wherein the metal catalyst is selected from the group consisting of platinum (Pt), palladium (Pd), mixtures of metals Pt and molybdenum (Mo), mixtures of Pt and cobalt (Co), mixtures of Pt and ruthenium (Ru), mixtures of Pt and nickel (Ni), mixtures of Pt and tin (Sn), and combinations thereof.

4. The fuel cell of claim 1 wherein the oxide support comprises an oxide selected from the group consisting of cerium oxide, manganese oxide, and combinations thereof.

5. The fuel cell of claim 4 wherein the metal catalyst is selected from the group consisting of platinum (Pt), palladium (Pd), and combinations thereof.

6. The fuel cell of claim 1 wherein the additive layer further comprises an ionomer.

7. The fuel cell of claim 1 wherein the ion conducting polymer comprises a perfluorosulfonic acid polymer.

8. The fuel cell of claim 1 wherein the ion conducting membrane comprises a copolymer having a polymerization unit based on a perfluorovinyl compound represented by:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

9. The fuel cell of claim 1 wherein the ion conducting membrane comprises a hydrocarbon membrane.

10. The fuel cell of claim 1 wherein the ion conducting membrane comprises a membrane selected from the group consisting of homogenous membranes and non-homogeneous membranes.

11. The fuel cell of claim 1 wherein the ion conducting membrane is a reinforced membrane that further comprises a support.

12. The fuel cell of claim 1 wherein the metal catalyst is present in an amount from about 0.01 mg/cm² to about 0.8 mg/cm².

13. The fuel cell of claim 1 wherein the oxide is present in an amount from about 0.01 mg/cm² to about 0.8 mg/cm².

14. The fuel cell of claim 1 wherein the base layer has a thickness from about 0 to about 50 microns and the additive layer has a thickness from about 0.5 to about 30 microns.

15. A fuel cell comprising:
an anode;
a cathode; and
an ion conducting membrane interposed between the anode and cathode, the ion conducting membrane comprising a base layer that includes an ion conducting polymer and an additive layer including a precious metal catalyst supported on an oxide, the oxide comprises a component selected from the group consisting of cerium oxide, manganese oxide, and combinations thereof.

16. The fuel cell of claim 14 wherein the additive layer further comprises an ionomer.

17. The fuel cell of claim 14 wherein the ion conducting polymer comprises a perfluorosulfonic acid polymer.

18. The fuel cell of claim 14 wherein the ion conducting polymer comprises a copolymer having a polymerization unit based on a perfluorovinyl compound represented by:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

19. The fuel cell of claim 1 wherein the metal catalyst is present in an amount from about 0.001 mg/cm² to about 0.8 mg/cm² and the oxide is present in an amount from about 0.001 mg/cm² to about 0.8 mg/cm².

20. A method of forming a membrane electrode assembly for a fuel cell, the method comprising:
forming an additive mixture comprising a metal catalyst and an oxide;
reacting the additive mixture with a reducing agent to form solid particles of the metal supported on the oxide;
collecting the solid particles of the metal supported on the oxide;
combining the solid particles with an ionomer to form an additive/ionomer mixture;
applying the additive ionomer mixture to a base layer to form a multilayer membrane having an additive layer disposed over the base layer;
applying a cathode to the multilayer membrane proximate to the additive layer; and
applying an anode to the multilayer membrane proximate to the base layer.
